(19) United States
(12) Patent Application Publication
(10) Pub. No.: US 2014/0201966 A1
(43) Pub. Date: Jul. 24, 2014

(54) DEVICE AND METHOD FOR AUTOMATICALLY WEAVING SEAL SEGMENTS

(71) Applicant: LEXINGTON RUBBER GROUP INC., Twinsburg, OH (US)

(72) Inventors: Todd Allan Campbell, Bolivar, OH (US); Jonathan Richard Hanna, Massillon, OH (US); John C. Miller, North Canton, OH (US); Cortney Wayne Mullen, Bolivar, OH (US)

(73) Assignee: LEXINGTON RUBBER GROUP INC., Twinsburg, OH (US)

(21) Appl. No.: 13/746,138

(22) Filed: Jan. 21, 2013

(51) Int. Cl. B23P 15/00

(52) U.S. Cl. CPC B23P 15/00
USPC 29/428; 29/700

(57) ABSTRACT

According to an aspect of the invention a device and method for automatically weaving seal segments is provided. The device includes at least one irregularly shaped disk-like member configured for rotation through a stacked assembly of seal segments to weave the seal segments. In another aspect of the invention, a method of automatically weaving seal segments to create a woven seal assembly for use with a medical device is provided wherein the disk-like member is rotated through a plurality of semi-overlapped seal segments to weave the seal segments into the woven seal assembly.

### FIELD OF THE INVENTION

The invention generally relates to a device and method for automatically weaving seal segments to create a woven seal assembly for use with a medical device, such as a trocar.

### BACKGROUND OF THE INVENTION

It is well known in the field of medical devices to provide sealing structures to facilitate entrance and exit of surgical devices into and out of a patient's body during an endoscopic procedure. One such device is a trocar assembly used to gain access to the body cavity. Such devices are able to provide a seal around the surgical instrument during the procedure to prevent fluids from entering or leaving the cavity.

In a typical arrangement, at least one of the sealing portions of the trocar assembly is made from a plurality of seal segments that are laboriously and intricately interwoven into a woven assembly by hand by underpaid laborers. Such a process is time consuming, difficult to maintain in a sterile environment, and physically demanding on the workers themselves, often leading to such ailments as carpal tunnel syndrome.

In view of the disadvantages associated with currently available processing of weaving the seal segments, a quick, efficient, cost-saving device and method is needed that not only removes the health risk to the workers, but also provides uniformity to the woven parts.

### BRIEF DESCRIPTION OF THE INVENTION

An embodiment of the invention provides a device for affecting the automatic seal segment weaving. The device includes an irregularly shaped disk-like member configured for rotation through a stacked assembly of seal segments to weave the seal segments.

In another embodiment of the invention, a method of automatically weaving seal segments to create a woven seal assembly for use with a medical device is provided wherein the disk-like member is rotated through a plurality of semi-overlapped seal segments while maintaining a central opening substantially near the center of the seal segments, such that a tip of the disk-like member passes through the central opening while edges extending from the tip of the disk-like member cause the plurality of seal segments to become weaved into the woven seal assembly.

### BRIEF DESCRIPTION OF THE FIGURES

A more particular description of the invention briefly described above will be rendered by reference to specific embodiments thereof that are illustrated in the appended drawings. Understanding that these drawings depict only typical embodiments of the invention and are not therefore to be considered to be limiting of its scope, exemplary embodiments of the invention will be described and explained with additional specificity and detail through the use of the accompanying drawings in which:

FIG. 1a is an exploded perspective view of a framed seal assembly of the prior art shown in an unassembled manner;

FIG. 1b is a perspective view of the assembled framed seal assembly of FIG. 1a;

FIG. 2a is a top view of the seal segment of FIG. 1;

FIG. 2b is an end view of the seal segment taken along section A-A of FIG. 2a;

FIG. 2c is a perspective view of the seal segment according to FIG. 2a;

FIG. 3 is a perspective view that illustrates a seal segment positioned upon a platform;

FIG. 4 is a perspective view that illustrates a second seal segment positioned upon a platform;

FIG. 5 is a perspective view that illustrates a third seal segment positioned upon a platform;

FIG. 6 is a perspective view that illustrates a fourth seal segment positioned upon a platform;

FIG. 7 is a top view of a hold down device according to an aspect of the invention;

FIG. 8 is a perspective view of the hold down device according to FIG. 7;

FIG. 9 is a top view of an irregularly shaped disk-like member according to an aspect of the invention;

FIG. 10 is a perspective view of the platform with seal segments and hold down device positioned for and before actuation of the automatic weaving process;

FIG. 11 is a perspective view that illustrates a portion of the weaving step of the method according to the invention;

FIG. 12 is a perspective view that illustrates a further step of the weaving step of FIG. 11;

FIG. 13 is a perspective view that illustrates a further step of the weaving step of FIG. 12; and

FIG. 14 is a perspective view of the woven seal assembly after the method of automatically weaving the seal segments has been conducted according to an aspect of the invention.

Various features, aspects, and advantages of the embodiments will become more apparent from the following detailed description, along with the accompanying figures in which like numerals represent like components throughout the figures and text. The various described features are not necessarily drawn to scale, but are drawn to emphasize specific features relevant to embodiments of the invention.

### DETAILED DESCRIPTION

Reference will now be made in detail to embodiments of the invention. Each example is provided by way of explanation of the invention, and is not meant as a limitation of the invention and does not constitute a definition of all possible embodiments.

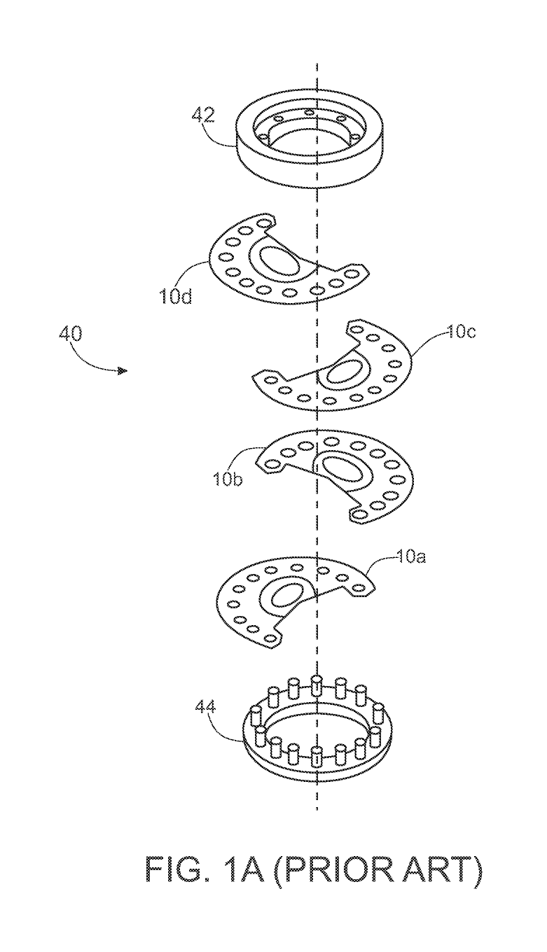

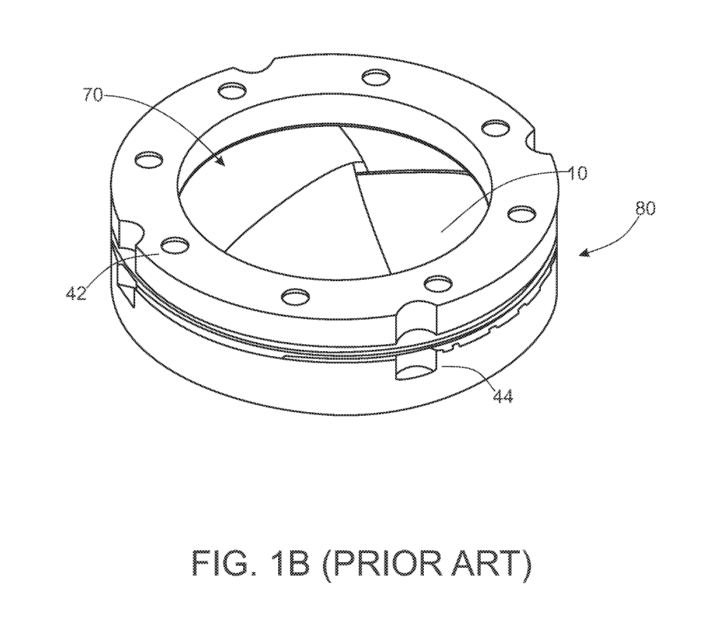

Now referring to FIG. 1a, a method of automatically weaving seal segments 10a, 10b, 10c and 10d, into a known seal assembly 40 is disclosed, the seal assembly shown in an unassembled manner. Examples of such seal assemblies useful in the method of the invention can be found in, for instance, U.S. Pat. No. 7,371,227 and U.S. Pat. No. 7,785,294, which are incorporated herein by reference in their entirety. A plurality of seal segments, as shown in this embodiment, four seal segments 10a, 10b, 10c and 10d, will be assembled in an overlapping, stacked fashion. Each of the seal segments 10 are positioned and arranged in an off-set fashion at an angle of approximately 90 degrees relative to its adjacent seal segment.

With reference to FIG. 1b, a known assembled framed seal assembly 80 of FIG. 1a is illustrated including female retaining ring or circular frame 42, which is typically positioned at an upper end of the seal assembly, and which will interconnect with male retaining ring or circular frame 44 positioned at a lower end of the seal assembly, with a woven seal assembly 70 positioned therebetween. As used herein, the terms “upper” and “lower” have no meaning other than for purposes of describing the positioning relative to the seal segments and are not intended to imply any particular arrangement for which the assembly would be used in the medical device, such as a trocar. The plurality of seal segments 10 are automatically interwoven into the woven seal assembly 70 as discussed in greater detail below.

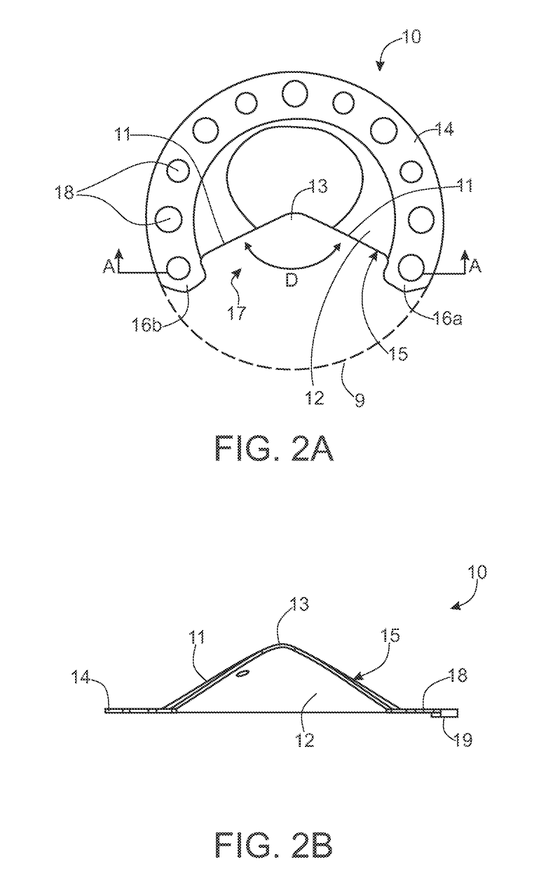

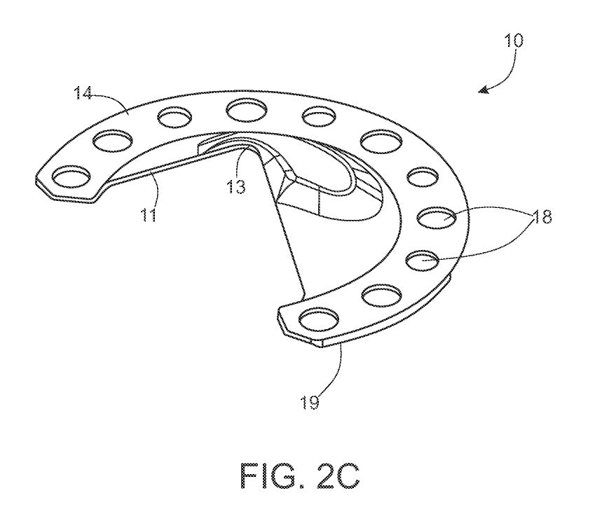

As shown in FIGS. 2a, 2b and 2c, and in an embodiment, each seal segment 10 of the plurality of seal segments may include a body 12, which in an embodiment, forms a partial cone-shape as seen herein. The body 12 preferably includes a semi-circular peripheral outer edge 14 opposite a non-circular inner edge 15. The non-circular edge is preferably formed of two mostly straight edges 11, which rise upwardly and meet at a central apex 13. In an embodiment, an angle D formed between straight edges 11 ranges between about 110 and about 140 degrees, preferably between about 120 and about 130 degrees, and more preferably about 125 degrees. The outer semi-circular edge 14 preferably joins the non-circular edge 15 at a first protruding arm 16a on one end and at a second protruding arm 16b on the other end, and forms the body portion between the peripheral edge 14, non-circular edge 15 and arms 16a and 16b. In other words, the peripheral edge 14 of the body portion 12 does not extend between a space 17 defined by a circumference shown by phantom, dotted line 9, protruding arms 16a/b and non-circular edge 15. As viewed in FIG. 2a, the seal segment generally takes the form of a Pac-Man®, the character made popular by the 1980's electronic game in which the Pac-Man was moved by the game player to eat its way through a maze. Arrangements of such seal segments are thus commonly referred to as a pacman seal. In an embodiment, each of the seal segments are formed from urethane rubber and are configured to be about one inch (2.54 cm) in diameter.

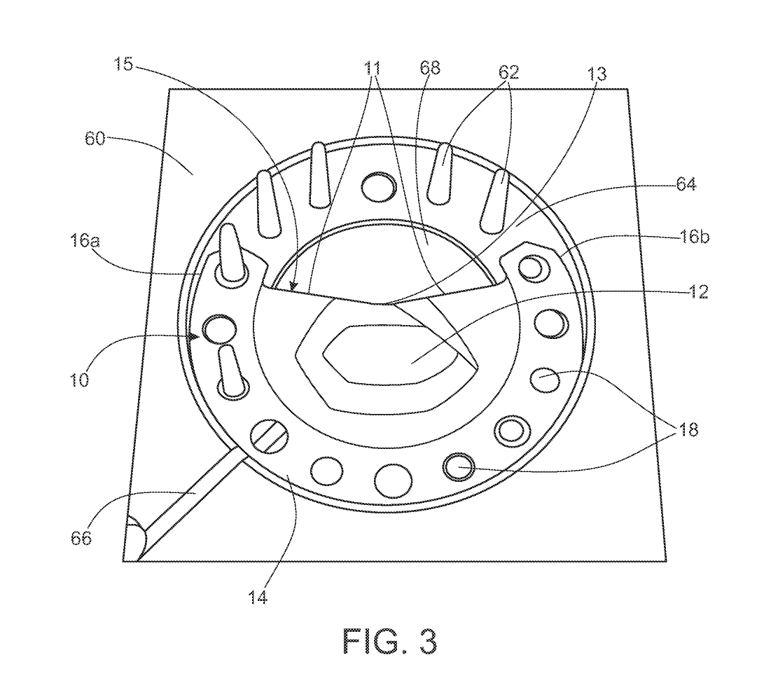

In an embodiment, a central portion of the body 12 may form a partial cone shape as best seen in FIGS. 2b and 2c. Turning again to FIG. 2a, the semi-circular peripheral edge 14 includes a plurality of spaced apart seal segment aligning apertures 18, which function as a means for aligning and receiving therethrough a plurality of protrusions 62 (see FIG. 3) and a hold down device (see FIG. 8 discussed hereinbelow). In an embodiment, each of the plurality of seal segments has eleven aligning apertures 18. The protrusions 62 extend from a recessed portion 64 of a platform 60 for placement and alignment of the seal segments as discussed in greater detail below. Turning again to FIG. 2a, the non-circular edge 15 of the seal segment 10 preferably includes a central apex 13, from which mostly straight edges 11 depend. On one end of the outer peripheral edge 14, where the edge 14 joins with the protruding arm 16a, a flap or lip 19 (see FIGS. 2b and 2c) extends from a lower surface of the semi-circular peripheral edge 14 and serves the function of assisting alignment of the seal segments 10 during the weaving process.

In an embodiment, a method for automatically weaving seal segments to create a woven seal assembly for use with a medical device is provided. Generally speaking, a plurality of seal segments are arranged upon a platform in a semi-overlapping manner, such that when so arranged, each of the plurality of seal segments are off-set while portions thereof overlap. With reference again to FIG. 3, a seal segment 10 is arranged or positioned upon the platform 60 as a beginning step for automatically weaving the plurality of seal segments. As shown herein, the platform 60 includes the circular recessed portion 64 from which extends a plurality of the spaced apart protrusions 62 along a peripheral edge of the recessed portion 64. In an embodiment, the protrusions 62 have a conically tapered shape wherein the end that attaches to the recessed portion 64 has a larger diameter than the opposing end. In an embodiment, the protrusions 62 have been strategically positioned, sized, shaped and arranged upon the recessed portion 64 of the platform 60 to not only receive the seal segments, but also to receive and position the hold down device (as discussed in greater detail below). The platform further includes a through-hole 68 and slot 66 which extend between an upper and lower surface of the platform for alignment and positioning of an irregularly shaped disk-like member, as discussed further hereinbelow. In an embodiment, when the seal segment 10 is arranged or placed upon the platform 60, the protrusions 62 extend through the seal segment aligning apertures 18. As shown herein, a first protrusion 62 extends through a first aligning aperture 18, which is positioned in protruding arm 16a, no protrusion 62 extends through an adjacent or second aligning aperture 18, and a second protrusion 62 extends through a next or third aligning aperture 18. The seal segment 10 is thus situated within, and seated upon, a horizontal surface of the recessed portion 64. As also shown herein, the outer peripheral edge 14 of the seal segment 10 is adapted for positioning within, and being received by, the recessed portion 64, the peripheral edge 14 abutting or nearly abutting a vertical surface of the recessed portion 64.

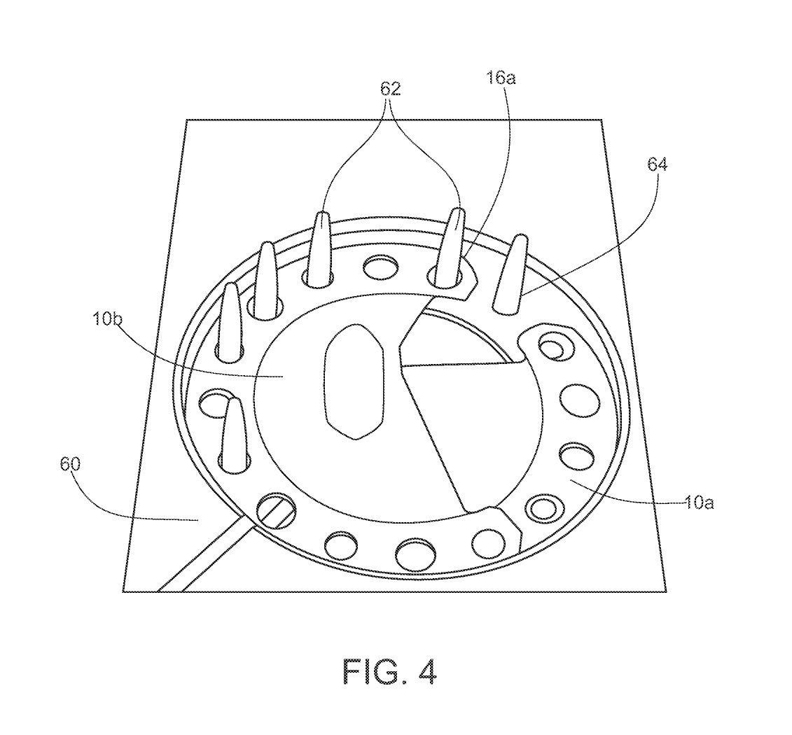

Turning to FIG. 4, an additional or second seal segment 10b is arranged or placed upon the first seal segment 10a. In an embodiment and as shown herein, the second seal segment 10b is positioned in a semi-overlapping fashion upon the first seal segment 10a so that only a portion of the second seal segment 10b overlaps a portion of the first seal segment 10a. As shown, the second seal segment 10b is also arranged at an angle of approximately 90 degrees from the first seal segment 10a. Further as shown herein, aligning apertures 18 of the second seal segment 10b receive at least two protrusions 62 extending from the recessed portion 64 of the platform 60. In fact, the aligning apertures 18 receive five of the protrusions 62 in the illustrated embodiment. Further, a protrusion 62 extends through an aligning hole 18 positioned in protruding arm 16a.

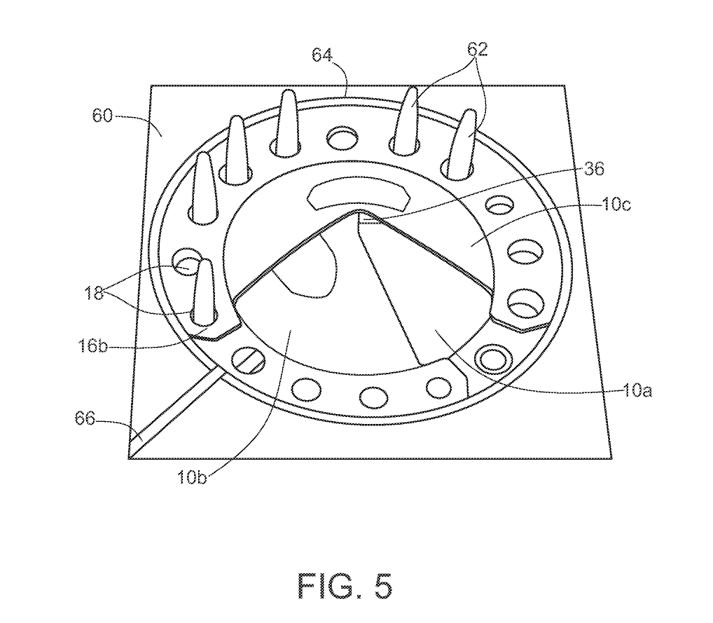

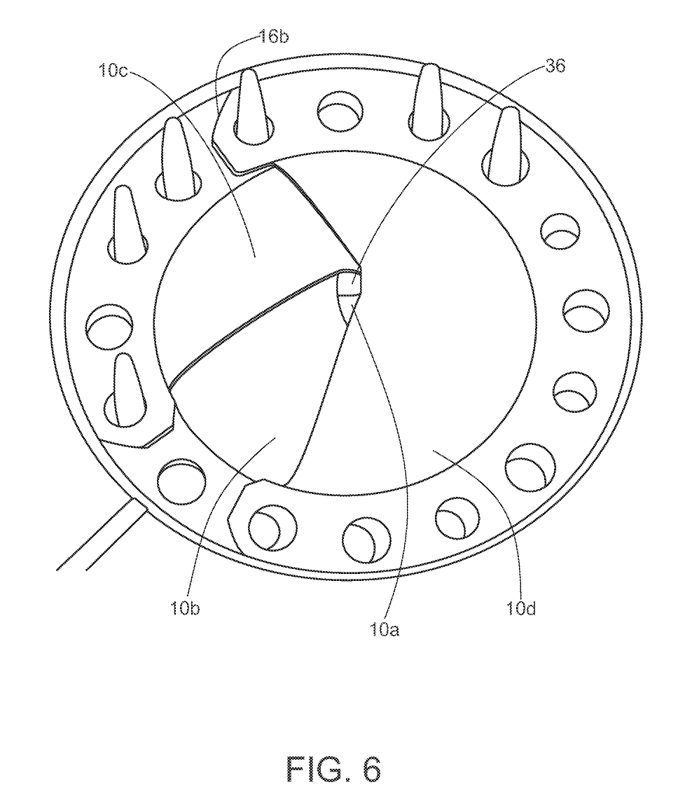

FIG. 5 illustrates arrangement of a third seal segment 10c in a semi-overlapping, offset fashion atop seal segment 10b. As seen herein the third seal segment 10c also partially overlaps a portion of the first seal segment 10a. Once again, certain protrusions extend through certain aligning apertures 18. In an embodiment, a protrusion 62 extends through an aligning aperture 18 formed in protruding arm 16b. Now that the third seal segment 10c has been arranged upon the other seal segments, a central opening 36 remains. This central opening 36 will also still be visible once a fourth seal segment 10d is placed upon the third seal segment 10c (FIG. 6). The central opening 36 is configured to receive a tip of the disk-like member, which will pass through the central opening 36 during the weaving process, as further discussed hereinbelow.

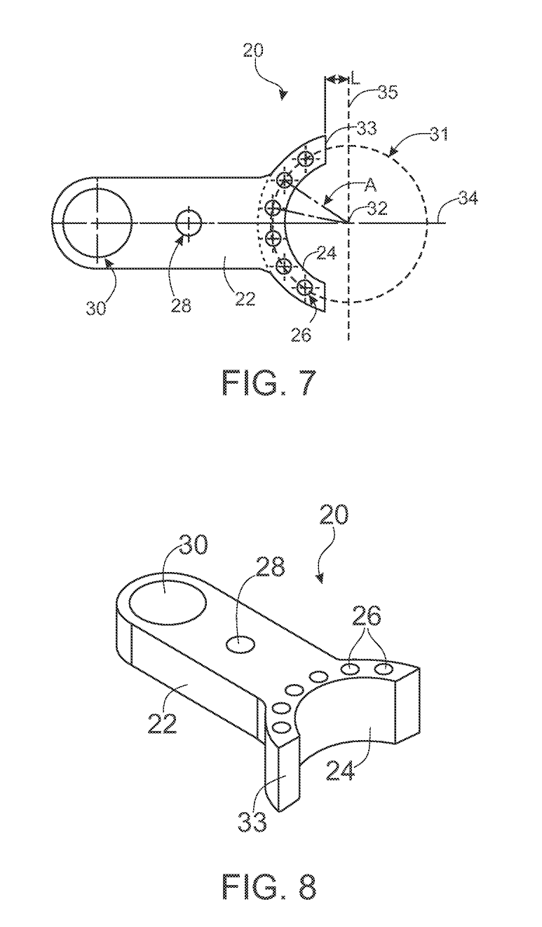

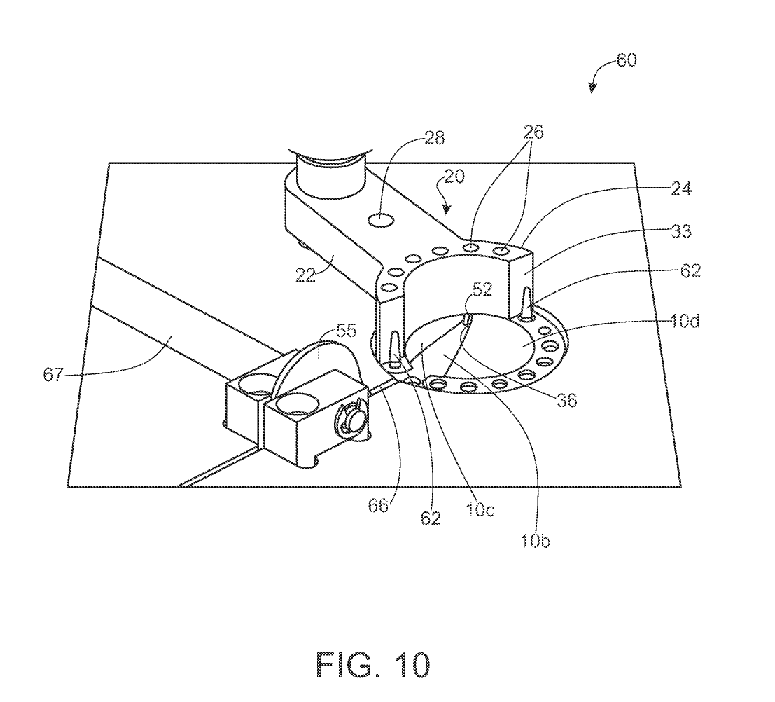

Once each of the seal segments have been arranged upon the platform, a pressure is applied to at least a portion of the topmost seal segment of the plurality of seal segments to maintain a position of the seal segments while the weaving is affected. In a preferred embodiment and with reference to FIGS. 7 and 8, a hold down device 20 is configured to function to apply the pressure to the stacked, semi-overlapped seal segments. In an embodiment, a handle 22 forms a major portion of the hold down device 20, from which extends a keeper 24. A centerline 34 is illustrated along a phantom line that extends substantially along the handle 22 of the hold down device 20. In an embodiment, the handle includes an aligning bore 28, situated centrally through the handle 22 for aligning the hold down device 20 relative to the platform 60 (as seen, for instance in FIG. 10. In an embodiment, a handle bore 30 is further provided at a rear portion of the handle 22, which is also configured for positioning of the hold down device 20 relative to the platform 60. Extending from the handle 22 is the keeper 24. The keeper includes a plurality of spaced apart keeper through-holes 26. Each end of the keeper 24 terminates in a forward edge 33. A phantom circumference 31 intersects a center of each of the keeper through-holes 26, and a center point 32 resides in the center of the phantom circumference 31. An angle A is defined as the angle between a center of adjacent keeper through holes 26 as illustrated in FIG. 7. In an embodiment, the angle A is about 22.5 degrees. The keeper through-holes 26 are radially spaced along the phantom circumference 31. In any case, the size and position of the holes 26 are coincident with at least some of the plurality of protrusions 62, (see, for instance, FIG. 10), for positioning the keeper for applying pressure to at least a portion of the topmost seal segment of the plurality of seal segments to maintain a position of the seal segments while the weaving is affected. As will be readily understood by one of ordinary skill in the art, such dimensions will also be adjustable based on the type and configuration of seal segments to be woven.

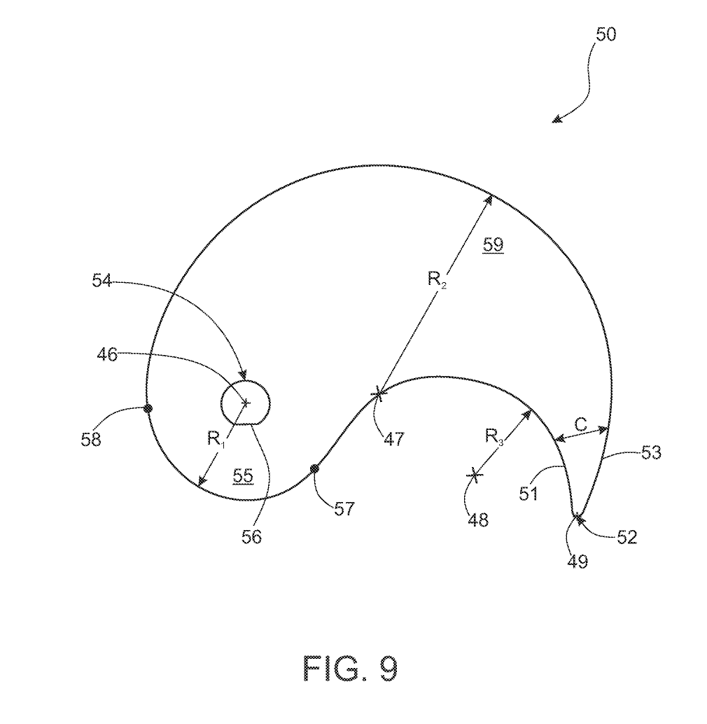

Turning to FIG. 9, a device for automatically weaving seal segments is illustrated. In an embodiment, the device includes an irregularly shaped disk-like member, which is configured for rotation through a stacked assembly of seal segments. Once the features of the disk-like member 50 are described, a description of how the disk-like member affects the automatic weaving of the seal segments to create a woven seal assembly will be discussed in greater detail. The disk-like member 50 includes a base portion 55, from which extends an extending portion 59. A disk bore 54 is positioned between the base portion 55 and the extending portion 59. The base portion 55 extends between points 57 and 58, and has a radius of curvature R1 from a center 46 of the disk bore 54. The disk bore 54 of the base portion 55 is configured to receive a rotating member (see, for instance, FIG. 10) such that when the disk-like member is rotated about the disk bore 54, the tip 52 extends through the central opening 36. In an embodiment, a flattened edge 56 is formed in the disk bore 54 to facilitate connection to the rotating member and to prevent the rotating member from slipping within the disk bore 54.

The extending portion 59 extends from the base portion 55 and terminates at the tip 52. The tip 52 is positioned at the end of the disk-like member 50 opposite the disk bore 54. In an embodiment, the tip 52 is rounded or blunted so as to avoid damaging the seal segments during the weaving process.

Extending back towards the base portion 55 from the tip 52, the extending portion 59 further includes two diverging, non-concentric edges that extend away from the tip 52. An inner edge 51 extends along an inner side of the tip 52 while an outer edge 53 extends along an outer, opposite side from the tip 52. In an embodiment, the inner edge 51 extends between the tip 52 and a point 57. Point 57 is the point where the base portion 55 meets the inner edge 51. The inner edge 51 has a curvature of radius R3 from a center 48. The outer edge 53 extends between the tip 52 and point 58. Point 58 is the point where the base portion 55 meets the outer edge 53. The outer edge 53 further has a curvature of radius R2 from a center 47. In an embodiment, the outer edge diverges away from the inner edge as illustrated by distance C, which increases between the diverging edges as the edges move away from the tip 52 towards the base portion 55. In an embodiment, the curvature of radius R2 is larger than the curvature of radius R3.

In an embodiment, the tip 52 has a radius from a center 49 of about 16/1000 in., the disk-like member 50 has a thickness of about 31/1000 in. (0.078 cm), R3 is about 410/1000 in., R1 is about 313/1000 in. and R2 is about 750/1000 in.

As shown in FIG. 10, after the final seal segment 10d is arranged upon the seal segment 10c, the hold down device 20 is positioned to apply pressure to an upper surface of the topmost seal segment, in this case seal segment 10d. In an embodiment, the keeper 24 of the hold down device 20 is positioned atop the stacked seal segments 10 and to apply a pressure thereupon to keep the seal segments 10 in place during the automatic weaving process. In an embodiment, the protrusions 62, which extend through aligning apertures 18 of the seal segments 10 further extend into the keeper through-holes 26, thus aligning the keeper 24 for applying pressure upon the seal segments.

Once the hold down device 20 is aligned with at least some of the plurality of protrusions 62, a lower surface of the hold down device 20 contacts an upper surface of at least a portion of one or more seal segments 10. Further, the lower surface of the keeper 24 is configured to be received in the recessed portion 64 of the platform 60. A majority of the plurality of protrusions 62 cannot be seen once the keeper 20 is positioned for applying pressure.

Once the plurality of seal segments are positioned upon the platform, pressure is applied to at least a portion of the seal segments, and the disk-like member 50 is rotated through the assembly of seal segments to affect the weave. In general, the disk-like member 50 is configured to affect the weave without human intervention. In other words, the arrangement and interoperability of the platform, seal segments, hold-down member and disk-like member all cooperate to automatically affect the weave without the need for human hands. By automatically it is meant that the process works by itself with little or no direct human control. In fact, many of the steps described herein may be applied automatically. In an embodiment, all of the steps are performed automatically.

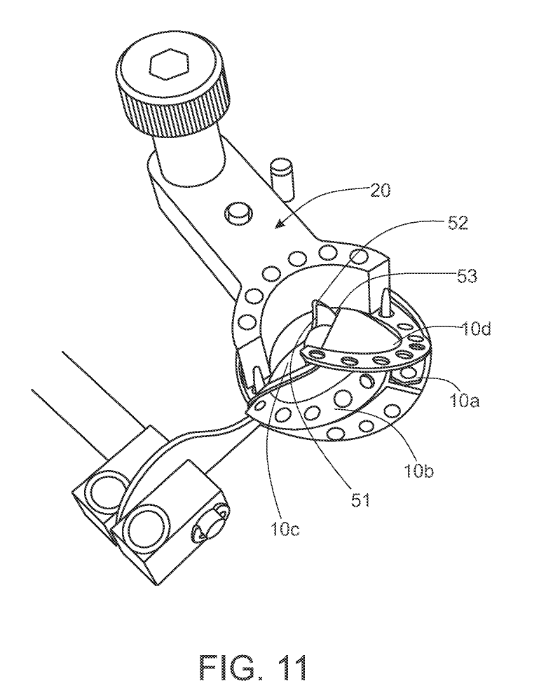

As illustrated herein, the rotating member 67 extends through a block within which the disk-like member 50 is positioned. An edge of the base portion 55 is seen in this view. The disk-like member 50 is positioned below the surface of the platform 60. Upon rotation of the rotating member 67, the disk-like member 50 begins to rotate through the weaving process, and as illustrated in FIG. 11, the tip 52 is just beginning to pass through the central opening 36 between all of the arranged and stacked seal segments 10a, 10b, 10c, and 10d.

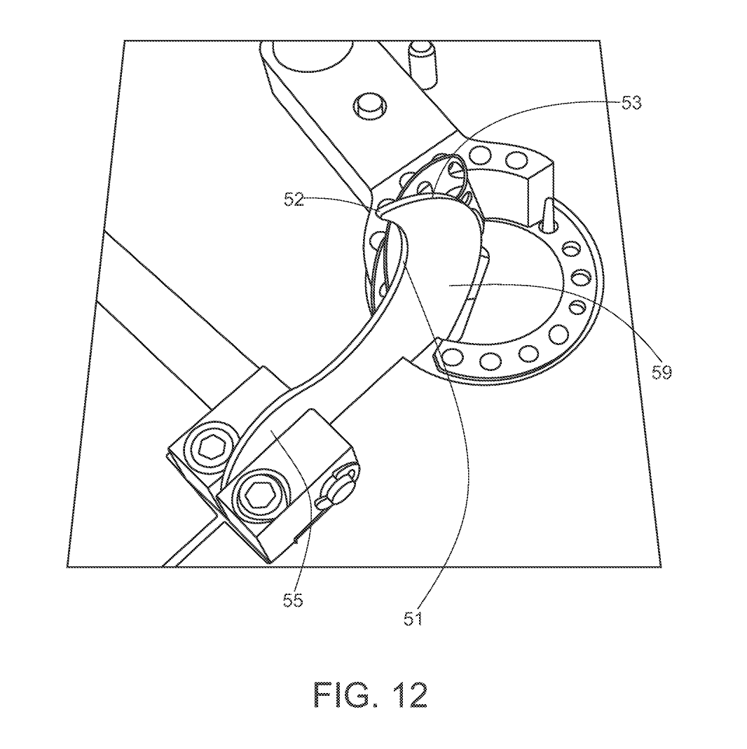

As the tip 52 passes/pushes through the central opening 36, inner and outer edges (51, 53) of the disk-like member 50 cause the plurality of seal segments to become weaved into the woven seal assembly 70. In an embodiment, the individual seal segments progressively drop off of the respective inner and outer edges (51, 53) to affect the weave as seen in FIGS. 10-14.

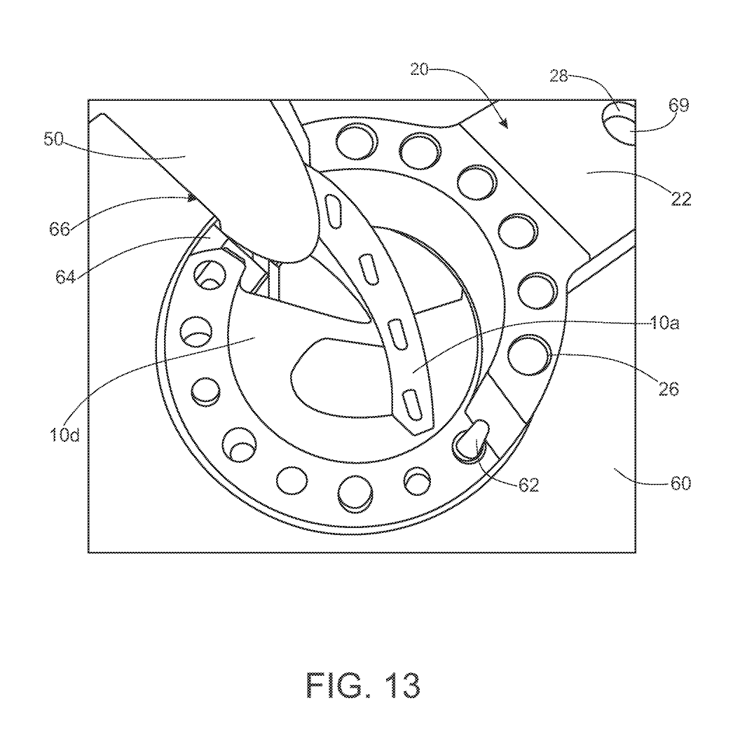

As shown in FIG. 13, the disk-like member 50 has almost completed its rotation through the seal segments 10, wherein the outer peripheral edge of seal segment 10a is flipped up by the disk-like member 50, and the outer edge 53 has almost completed the rotation.

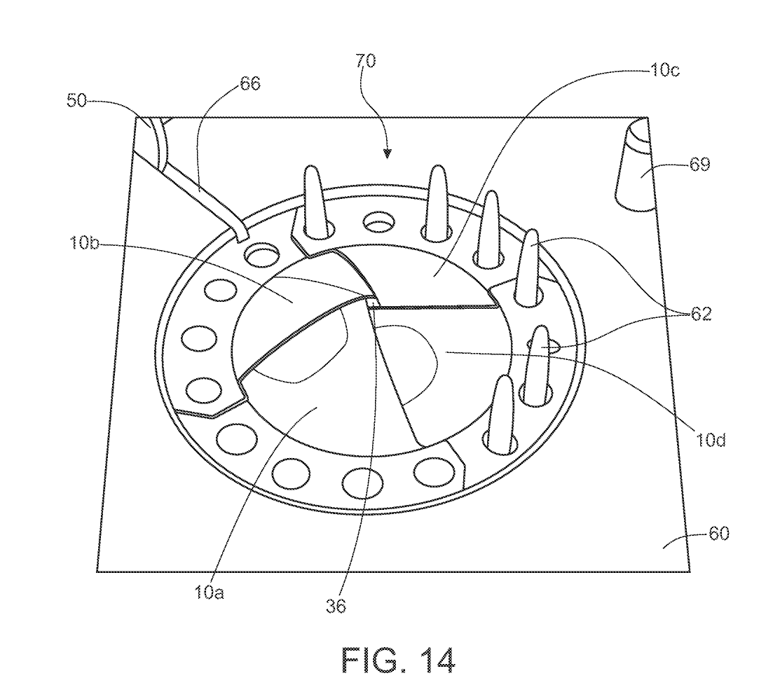

As seen in FIG. 14, the disk-like member 50 has completely passed through the assembly of stacked seal segments and weaving of the individual seal segments into the woven seal assembly 70 has been completed. The thus woven seal assembly 70 can be further assembled into the framed woven seal assembly 80 (FIG. 1b).

In an embodiment, each step of the process is performed automatically or robotically, thus replacing a former process that required hand assembly of the seal segments followed by hand weaving of the seal segments into the woven seal assembly.

In yet another embodiment, the seal segments are manually arranged upon the platform, and then the seal segments are automatically or robotically woven as described hereinabove into the woven seal assembly. It is also contemplated that the step of applying a pressure to the topmost seal segment may be done manually, followed by automatic weaving of the thus arranged and positioned seal segments.

The components and methods illustrated are not limited to the specific embodiments described herein, but rather, features illustrated or described as part of one embodiment can be used on or in conjunction with other embodiments to yield yet a further embodiment. It is intended that the invention include such modifications and variations. Further, steps described in the method may be utilized independently and separately from other steps described herein.

While the invention has been described with reference to a preferred embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof.

In this specification and the claims that follow, reference will be made to a number of terms that have the following meanings. The singular forms “a,” “an” and “the” include plural referents unless the context clearly dictates otherwise. Furthermore, references to “one embodiment” of the invention are not intended to be interpreted as excluding the existence of additional embodiments that also incorporate the recited features. Approximating language, as used herein throughout the specification and claims, may be applied to modify any quantitative representation that could permissibly vary without resulting in a change in the basic function to which it is related. Accordingly, a value modified by a term such as “about” is not to be limited to the precise value specified. In some instances, the approximating language may correspond to the precision of an instrument for measuring the value. Terms such as “first,” “second,” etc. are used to identify one element from another, and unless otherwise specified are not meant to refer to a particular order or number of elements.

As used herein, the terms “may” and “may be” indicate a possibility of an occurrence within a set of circumstances; a possession of a specified property, characteristic or function; and/or qualify another verb by expressing one or more of an ability, capability, or possibility associated with the qualified verb. Accordingly, usage of “may” and “may be” indicates that a modified term is apparently appropriate, capable, or suitable for an indicated capacity, function, or usage, while taking into account that in some circumstances the modified term may sometimes not be appropriate, capable, or suitable. For example, in some circumstances an event or capacity can be expected, while in other circumstances the event or capacity cannot occur—this distinction is captured by the terms “may” and “may be.”

As used in the claims, the word “comprises” and its grammatical variants logically also subtend and include phrases of varying and differing extent such as for example, but not limited thereto, “consisting essentially of” and “consisting of” Where necessary, ranges have been supplied, and those ranges are inclusive of all sub-ranges therebetween. It is to be expected that variations in these ranges will suggest themselves to a practitioner having ordinary skill in the art and, where not already dedicated to the public, the appended claims should cover those variations.

Advances in science and technology may make equivalents and substitutions possible that are not now contemplated by reason of the imprecision of language; these variations should be covered by the appended claims. This written description uses examples to disclose the invention, including the best mode, and also to enable any person of ordinary skill in the art to practice the invention, including making and using any devices or systems and performing any incorporated methods. The patentable scope of the invention is defined by the claims, and may include other examples that occur to those of ordinary skill in the art. Such other examples are intended to be within the scope of the claims if they have structural elements that do not differ from the literal language of the claims, or if they include equivalent structural elements with insubstantial differences from the literal languages of the claims.

What is claimed is:

1. A device for automatically weaving seal segments to create a woven seal assembly, the device comprising:
an irregularly shaped disk-like member configured for rotation through a stacked assembly of seal segments, the disk-like member comprising a base portion and an extending portion, the extending portion comprising a tip, an inner edge, and an outer edge, the inner edge extending along an inner side of the tip and the outer edge extending from an outer, opposite side from the tip, the outer edge diverging away from the inner edge.

2. The device of claim 1, further comprising: the inner edge extending between the tip and one point positioned along the base portion, the inner edge having a first curvature of radius, and the outer edge extending between the tip and another point positioned along the base portion, the outer edge having a second curvature of radius.

3. The device of claim 2, wherein the second curvature of radius is larger than the first curvature of radius.

4. The device of claim 2, wherein the base portion extends between the one point and the another point, and the base portion has a radius of curvature.

5. The device of claim 1, wherein the seal assembly is woven for use with a medical device.

6. A method of automatically weaving seal segments to create a woven seal assembly for use with a medical device, the method comprising:
rotating an irregularly shaped disk-like member through a plurality of semi-overlapped seal segments while maintaining a central opening substantially near the center of the seal segments, such that a tip of the disk-like member passes through the central opening while edges extending from the tip of the disk-like member cause the plurality of seal segments to become weaved into the woven seal assembly.

7. The method of claim 6 further comprising: applying a pressure to at least a portion of a topmost seal segment of the plurality of seal segments to maintain a position thereof.

8. The method of claim 7, wherein the step of applying a pressure comprises positioning a hold down device upon at least a portion of the topmost seal segment.

9. The method of claim 6, wherein the disk-like member comprising a base portion and an extending portion, the extending portion comprising the tip, and the edges comprising an inner edge and an outer edge, the inner and outer edges configured for weaving the plurality of seal segments.

10. A method for automatically weaving seal segments to create a woven seal assembly for use with a medical device, the method comprising:
arranging a plurality of seal segments upon a platform in a semi-overlapping manner, such that when so arranged, each of the plurality of seal segments are off-set while portions thereof overlap and while maintaining a central opening substantially near the center of the seal segments;
applying a pressure to at least a portion of a topmost seal segment of the plurality of seal segments to maintain a position thereof and
weaving the seal segments by rotating an irregularly shaped disk-like member such that a tip of the disk-like member passes through the central opening while edges extending from the tip of the disk-like member cause the plurality of seal segments to become weaved into the woven seal assembly such that when the woven seal assembly is removed from the platform, the plurality of seal segments remain interwoven.

11. The method of claim 10, further comprising:
off-set arranging at least one of the plurality of seal segments upon an adjacent seal segment at an angle of about 90 degrees.

12. The method of claim 11, wherein the plurality of seal segments comprise at least four seal segments.

13. The method of claim 12, wherein the step of arranging comprises arranging each of the seal segments in at least one quadrant.

14. The method of claim 10, wherein the plurality of seal segments comprise a first, second, third and fourth seal segment, and further wherein the first seal segment is arranged upon the platform, the second seal segment is off-set arranged upon the first seal segment at an angle of about 90 degrees, the third seal segment is off-set arranged upon the second seal segment at the angle of about 90 degrees, and the fourth seal segment is off-set arranged upon the third seal segment at an angle of about 90 degrees, and further wherein each of the seal segments partially overlap at least a portion of the adjacent seal segment.

15. The method of claim 10, wherein the step of applying a pressure comprises positioning a hold down device upon at least a portion of the topmost seal segment.

16. The method of claim 10, wherein each of the plurality of seal segments comprise a semi-circular peripheral edge from which a first protruding arm extends on one end and a second protruding arm extends on the other end.

17. The method of claim 16, wherein each of the plurality of seal segments further comprise a pair of protruding arms extending from a base to form a channel therebetween, the base including a plurality of retaining apertures for receiving protrusions extending from the platform.
